(19) United States
(12) Patent Application Publication
(10) Pub. No.: US 2010/0268629 A1
(43) Pub. Date: Oct. 21, 2010

(54) CONCRETE BUDGETING

(75) Inventors: Erik S. Ross, Charlotte, NC (US); Hans D. Schumacher, Charlotte, NC (US); Dan Ariely, Durham, NC (US); Sean M. Jones, Charlotte, NC (US); Ray Garcia, New York, NY (US); Kathleen L. Dooley, Pineville, NC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/426,403

(22) Filed: Apr. 20, 2009

(51) Int. Cl. G06Q 40/00

(52) U.S. Cl. 705/35

(57) ABSTRACT

Apparatus and methods for supporting a budgeting process are provided. A method according to the invention may include operating an electronic information processing platform to receive an electronic confirmation of one of a purchase, a savings transaction, and an investment transaction. The method may further include performing a reevaluation of a future savings goal in response to the confirmation. The method may also include performing one of the following in response to the reevaluation: 1) presenting an alternative to the future savings goal and 2) auto-executing a process. The auto-executing may be based on pre-determined rules.

### FIELD OF TECHNOLOGY

Aspects of the disclosure relate to systems and methods for supporting budgeting initiatives. All documents discussed herein are hereby incorporated by reference herein in their respective entirety.

### BACKGROUND

Savings trends continue to decline as credit becomes increasingly relied upon to fund current purchases.¹ The US Savings rate has been in decline since the 1980s.² ¹http://www.federalreserve.gov/releases/g19/Current/g19.pdf²http://www.research.stlouisfed.org/publications/review/07/11/Guidolin.pdf

Household net worth is also under pressure in the current economic cycle. If an economic decline occurs that is similar to the decline experience between 1998 and 2002, combined with the fact that consumers may not be able to use their homes to weather the economic cycle as they did during 1990s and indeed up until 2006, consumers will be under increasing economic forces.

Delinquencies continue to rise given the current economic cycle.³ It would be desirable to provide systems and methods that allow users to budget themselves and, thereby, conserve economic resources. ³http://www.aba.com/Press+Room/070208DelinquenciesFirst Quarter08.htm

### SUMMARY OF THE INVENTION

A method for determining the effect of a purchase on a budgeting goal is provided. The method may use an electronic information processing platform. The method may include receiving information from a participant regarding the intent to purchase an item. The information may be received via the platform. The method may further include determining the effect of the purchase on the goal. In response to an occurrence of the purchase the method may recalculate a goal strategy. In response to a registration of a failure to purchase, the method may include logging the purchase intent.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with the principles of the invention;

FIG. 2 shows an exemplary illustrative graphical interface that illustrates features of the present invention;

FIG. 3A is a first portion of a flow diagram of an illustrative process according to the invention;

FIG. 3B is a second portion of the flow diagram of the illustrative process shown in FIG. 3A according to the invention;

FIG. 4A is a first portion of a flow diagram of another illustrative process according to the invention;

FIG. 4B is a second portion of the flow diagram of the illustrative process shown in FIG. 4A according to the invention;

FIG. 5A is a first portion of a flow diagram of yet another illustrative process according to the invention;

FIG. 5B is a second portion of the flow diagram of the illustrative process shown in FIG. 5A according to the invention;

FIG. 6 shows an illustrative graphical interface that illustrates features of the present invention;

FIG. 7 shows yet another exemplary illustrative graphical interface that illustrates features of the present invention;

FIG. 8 shows still another exemplary illustrative graphical interface that illustrates features of the present invention;

FIG. 9 shows yet another exemplary illustrative graphical interface that illustrates features of the present invention;

FIG. 10 shows another exemplary illustrative graphical interface that illustrates features of the present invention; and

FIG. 11 shows an exemplary system architecture of a system according to the invention.

### DETAILED DESCRIPTION OF THE INVENTION

Conventional budgeting tools are primarily limited to post-transaction oriented analysis. Perhaps as a result of the post-transaction nature of the analysis, these tools are typically loosely integrated into a user's financial life. Users of Quicken™ and Microsoft Money™, for example, input their respective transactions, income, savings, and investment data after the actual financial event for analysis and for budgeting for the following time period(s).

Other financial products are also making similar in-roads into the personnel budget management. Online tools like Mint, Yodlee, Buxfer, BudgetTracker, BudgetPulse, PearBudget, Mvelopes, and others provide for management of short-term monthly goals. However, such tools typically do not attempt to project these views into the future to determine the impact on long-term financial goals. Nor do these tools provide for an on-demand analysis of a selected purchase's impact on attaining long-term financial goals. Rather, these, and other similar on-line financial planning, tools are mostly calculators or lead-in tools to promote the purchase of a personal financial advising service.

Companies like Fidelity™ and Vanguard™ provide a personal financial advisor to analyze one's current savings and investment goals and provide plans to achieve these goals. These plans are typically provided in written form but do not provide on-demand analysis of the effect of discrete purchases on current status or the effect of these purchases on attaining long-term financial goals.

Typically multiple personal meetings are needed to solidify a plan. Then additional visits are required in order to adjust the plan as conditions and goals change.

To further complicate the budgeting process, consumers are increasingly reliant on mobile devices to bank and purchase goods and services—a factor for which traditional planning processes fail to account. In fact, Deutsche Bank research indicates that 34.9 million users will bank using a mobile device by 2010.

Systems and methods for concrete budgeting (such systems and methods referred to hereinafter as “concrete budgeting”) according to the invention preferably provide a user real-time, graphics-based analysis of the effect of current and anticipated income and expenditures on long-term future financial goals. Such future financial goals may include retirement, college planning, etc. The tool is designed to incent socially responsible savings behavior. Such behavior may help consumers achieve ‘concrete’ future goals.

The following functionality is preferably encompassed by concrete budgeting:

One aspect of the invention preferably provides a user a series of questions/inputs for his/her long-term goals/objectives. Thereafter, the aspect may provide a series of preferably user-defined and/or system-set savings, investment, and expenditure categories. These, or other, categories may include specific goals/limits in order to attain the long-term goals provided.

In certain embodiments of the invention, each income stream and savings and investment vehicle(s) could be integrated into the tool as well as all expenditure transactions—e.g., credit and/or debit card transactions—for monitoring achievement of the ‘concrete’ future as characterized by the user's goals.

Concrete budgeting can also take inputs and create linked categories that provide a long-term budget to achieve the financial goals and identify any immediate obstacles to achievement.

Another feature of the invention relates to sensitivity analysis. At any given time, a real-time sensitivity analysis can be performed to graphically display to a user how behaviors could be altered—e.g., by foregoing a particular expenditure(s)—in order to attain the user's future goals sooner.

Further, concrete budgeting can recommend certain possible paths to financial goal achievement from which a user can select. As income level and goals change, the concrete budgeting can preferably dynamically adjust goals in order to attain the predetermined objectives. Such adjustment may be implemented based on data previously input by the user. Certain embodiments of the invention may be available on a mobile device to guide decision-making wherever the user is located—e.g., at a point-of-purchase. Such an application may preferably be used to control certain types of impulse purchasing.

Certain embodiments of a software and/or hardware tool according to the invention could substantially continuously monitor inflow and outflow transactions in order to compute the achievement status of long-term financial goals. Such embodiments could also recommend funding vehicles for purchases, mechanisms for debt consolidation, mortgage refinance and/or other suitable tools in order to attain financial goals.

Embodiments of a tool according to the invention could provide on-demand decision data for impulse purchases. For example, perhaps a person has input a goal to retire in 15 years with five million dollars. Such a user may have provided the guidelines to set up the savings and expenditure budgets necessary to achieve these goals.

The user may then attend an electronics trade-show and decide he or she needs a newly-introduced electronic device which is priced at $3,000. The user could then access a concrete budgeting tool using a mobile device and input the purchase amount, and, possibly, the purchase characteristics. Thereafter, the user could perform a sensitivity analysis on how the purchase impacts the user's long-term retirement goal. Such an embodiment of the invention could enable the user to balance the attainment of the future goal with the perceived pleasure utility of having the device now. Concrete budgeting may indicate that this purchase will extend the attainment of a pre-determined retirement goal by one (1) year. The user can then make an informed decision whether to proceed with the purchase.

Additionally, if a user stays within a defined budget over a user-defined and/or system-set time period for a particular spending category, concrete budgeting may automatically invest a category surplus into a specified BAC savings or investment vehicle to enable goal attainment or reduce a current expense—e.g., prepay a mortgage, pay off a credit card balance, etc. A user could also earn reward points if the user remained within his spending category limits. Such reward points may apply to selected products and/or product lines.

If, during a given user-defined time period, a user overspends on a particular budget category, the user can configure predefined ‘penalties’ to direct concrete budgeting to take appropriate actions. One action could be to define a spending category from which the deficit will be funded. Penalties could include declination of the user's credit/debit card(s) at point-of-sale (POS). The user could also setup a proactive alert message that indicates that the user is within a predetermined percentage amount of the user's spending category limit for the defined time period (weekly, monthly, etc.) in order to allocate the user's funds differently within the defined time period to compensate for current expenditure patterns.

Some embodiments of the tool according to the invention may suggest changes in expenditures and/or in savings and investment vehicles in order to achieve goals sooner than planned. In one exemplary case, a user's budget includes a discretionary expenditure budget of $50 per month on coffee. Further, a user's transactions indicate that the user consumes the full discretionary budget every month. Concrete budgeting can provide an option for a change in behavior to shift to $30 per month and invest the difference, $20, in a mutual fund, or some other suitable investment vehicle, in order to attain a specific goal at an earlier timeframe.

In other aspects of the invention, a user could perform a comparison to ‘others like me’ based on the available data and suitable algorithms. Such algorithms may include current financial behavior (deposits, transaction history, credit, mortgage, buying behaviors, geo/spatial data, census data, and so forth) that would show the user how the user compares to others who are similarly economically situated.

Once a user attains the goal—e.g., retirement—concrete budgeting can provide for a decumulation strategy—i.e., a strategy that manages future expenditures and other future obligations such as bequests.

Concrete budgeting can also use multimedia applications to customize the user's personal experience. For example, a user could define a melody or a video, or the melody or video could be system-set, that is played to reinforce certain behaviors. Such behaviors may be reinforced, for example, by playing a melody or video upon reporting of earned interest on a savings account. Other temporal events that may trigger multimedia include actions such as purchasing an item, approaching a ceiling for a particular budget category, staying within a defined budget category for an evaluation period, or achievement of a goal.

In certain embodiments of the invention, users can share at least one of their current budget, expense or goal items with a defined ‘friends’ network. The friends network may be open to certain selected group within the concrete budgeting application or, in another embodiment, may be open to with the entire concrete budgeting user base community. With respect to the friends network, the user could first setup the network in which he or she would like to share an expense/goal category. Such sharing could be implemented by inviting other users to view these items.

Concrete budgeting could provide transparency into the particular item shared by allowing the friend(s) to view all the details related to the selected item. Concrete budgeting could also provide a platform for friends to provide comments on observed behaviors in order to encourage spending less and saving more in order to reach the financial goals.

Within a user's defined friend network, friends could commit and/or contribute gifts to another user that achieves their respective financial goals. For example, if a grandparent was a participant in the friend network of a grandchild, the grandparent could commit a financial gift to the grandchild on the condition that the grandchild achieves a particular goal or a milestone of a goal. Such gift may be in the form of a matching contribution, a commitment to an investment, or some other suitable gift.

In certain embodiments, all of a household's accounts could be assigned to the same budget and goals, thereby providing transparency and insight into everyone's behaviors. In addition, sub-expense categories, budgets, and goals could be created and included in the household budget, expenses, and goals.

Utilizing geo-spatial capabilities embedded in a mobile device, many additional concrete budgeting features can be provided. Such features may include proactively reminding the user of certain aspects of his or her financial health. For example, upon entering a retailer, the retailer which may be identified to a concrete budgeting application using geo-spatial data, the phone could play a predefined melody to indicate to the user that he or she spent too much at this location previously. Alternatively, a concrete budgeting application could remind the user of the last transactions that occurred at the retail location or the current budget for this particular expense category. In another embodiment of the invention, the concrete budgeting application could play a video or some other multimedia item to provide feedback to the user in an attempt to reinforce and/or modify a behavior.

Targeted behavioral advertising could be used by retailers, merchants, product manufacturers, and service providers to assist a user with a particular budget item or category. Receiving these dynamic coupons could be on an ‘opt-in’ basis—i.e., only upon user agreement to the advertising—and would only be transmitted based on a combination of budget, expenses, goals, and behaviors.

Given the on-demand nature of concrete budgeting, an application according to the invention can be accessible via a mobile device equipped with the ability to enable relevant web applications. Such applications can include a highly-graphically oriented display application in order to further enable appropriate decisioning. In certain embodiments of the invention, initial setup can be managed through a PC/Mac graphical user interface (“GUI”).

Concrete budgeting can also provide multiple opportunities to address gaps in current product offerings. For example, concrete budgeting can use various cash streams such as from savings, investments, and to planned, and unplanned expenditures in order to create ‘concrete’ financial plans for each goal provided.

In certain embodiments of the invention, a user could link his/her credit/debit card, deposit, income streams, and other sources and sinks to concrete budgeting with available historical behavior. If historical data is not available, the application can use the currently available data and begin the sense and respond process as events unfold.

Concrete budgeting can provide for an on-demand analysis of the effect of current, planned, and/or impulse transactions on the achievement of long-term financial goals. Such analysis can be implemented on, or displayed on a mobile device or personal computer. A user can be provided with the long-term effects of a particular purchase. Such effects may include the effect of the purchase on reaching the goals as defined in the application. Concrete budgeting can also recommend a funding strategy for a purchase based upon current available financing, the user's financial health, and/or the user's long-term goals.

Concrete budgeting can also dynamically alter category expenditures if a user is trending downward in a particular expenditure category over a user-defined and/or system-set time period. In such instances, the user may elect to invest the surplus into a savings and/or investment vehicle, or can seek to compensate other spending categories where expenditures are trending higher and need to be offset. These sense and respond actions may be user-defined and/or system-set.

While a user could set up the application via a home and/or business computer connected to the internet via secured access, the application can also be accessible via an internet-enabled mobile device over a secure connection to perform similar actions as in the pc-user interface implementation.

This increased accessibility provides for on-the-fly decision-guiding capabilities with respect to any particular purchase event. Such decision-guiding capabilities may include providing information regarding the effects of the purchase events on long-term financial goals.

Preferably every user transaction can be tracked in real-time, pegged to the appropriate user-defined category, and evaluated in the user-defined timeframe compared to the respective defined budget. Such comparison may be implemented at least to determine current status with respect to goal achievement.

In one exemplary scenario, a user can setup multiple long-term financial goals that span 20-30 years. In order to manage the inflow/outflow cycles of the user's financial life, the user could define a timeframe goal evaluation period of 30 days that begins on the 5th of any given month and ends 30 calendar days thereafter, a quarterly view, a yearly view, a multi-year view of 5 years, etc. At the end of each of the timeframe goal evaluation periods, concrete budgeting may provide the user with an indication of progress towards the financial goals. The user could then be provided with a snapshot relative to the user-defined view as well as the long-term perspective of each particular goal.

Concrete budgeting could also provide a user with a comparison of the user's situation to his or her peer groups. For example, the user could be part of group that competes with respect to savings, investment, and reaching the user's financial goals. Concrete budgeting will mine credit/debit, deposit, geo/spatial, census, transaction history, concrete budgeting data, mortgage, HELOC, and other data and provide an overall health view of the user with respect to the appropriate peer group. The peer group could be user-selected, system-set and/or defined by some predetermined criteria.

In addition, concrete budgeting can use latitude/longitude-based user location data to generate coupons and special offers. For example, if a user is planning to purchase a large-screen television in the next month, a participating retail or product manufacturer could offer a coupon for a particular model based on the person's physical proximity to a known location. Such proximity may be determined using a mobile communications device. If no mobile device is available, a coupon could be generated based on an intent to purchase, but not necessarily be geo-spatially oriented.

A rewards algorithm can also be employed to offer incentives for a user to attain their goals. More particularly, the rewards algorithm can be used to incent incremental goal achievement throughout the duration of a long-term goal by offering points that can be applied against a number of rewards, or the paying down of a line-of-credit for example. In order to provide for ease of use, understanding, and simplified sensitivity analysis, a user interface can be primarily graphics-driven, including sliders, rollovers, drag-and-drop, panning, zooming, etc.

If desired, a user can access and/or view more granular detail about a selected goal, category, or item simply by selecting the item. Concrete budgeting can then provide a time-series view of how the goal is being fulfilled.

An issues summary can also be provided in the GUI to indicate any trouble areas that need to be addressed. The application can be touch-screen enabled for use with mobile devices and other surface technology based hardware. The GUI can also provide a color configuration with pre-defined colors resident in the application to allow a user to customize his/her view. In addition, the application can preferably support multi-language internationalization.

An electronic communication platform according to the invention can preferably enable an application according to the invention to provide for sense and respond algorithms that process multiple transactions in real-time. Such algorithms may provide users with immediate metrics, potential issues, messages, temporal events, and resulting transactions.

Message notifications about a current or future issue that result from the processing of a transaction can be sent immediately via text message, email, voice mail, instant message, or other available messaging mechanisms depending on the user-defined notification settings.

Concrete budgeting can preferably also contain a robust integration infrastructure that embraces current technology and exposes functionality with web services. In addition, the idea behind creating this application is that it serves to provide a means of attaining long-term savings goals.

Moreover, any financial institution that supports concrete budgeting may move from being regarded as a penal, fee-based corporate structure to a socially-responsible institution that employs resources and technologies to assist customers with attaining their life goals. By providing a path and metric directed to future financial comfort, concrete budgeting may provide a user a ‘concrete’ means for achieving his/her financial futures.

Other advantages of using a tool according to the invention may include helping consumers address economic pressure as well as provide for a means of attaining users' long-term financial futures by making them aware of the impact of their purchasing behavior. Concrete budgeting can provide an on-demand, mobile tool for users to evaluate their purchases and manage their impulse spending.

Credit card debt has risen to a record $790 Billion and is currently rising four times higher than earlier in this decade. A study has also indicated that 35% of U.S. card holders pay late. Concrete budgeting preferably provides a mechanism to allow users to live within their means and attain their long-term financial future as well as reduce the risk of delinquencies and charge-offs.

In order to facilitate setup of a system that receives and stores historical transactions, expenditures, savings, and investments, a tool can be pre-loaded with a number of merchant's and retailers—e.g., Krogers, Harris-Teeter, Safeway, Publix, Albertson's for the Groceries category. In addition, user interviews can be conducted to provide a default data set and default settings.

Alternatively, a machine-learning algorithm can be applied to the transactions to create default categories and to suggest goals based upon the user's behavior and peer network.

If a user is currently using MS Money or Intuit Quicken, or other financial tracking tool that supports a download or extract, concrete budgeting may be able to extract information from those tools to facilitate initial setup.

Savings and expenditure categories may be system-set and/or user-defined. In addition, concrete budgeting can provide a default set of spending categories which a user can modify as needed.

System-set and/or user-defined time periods—e.g., monthly, weekly, etc.—may be implemented to manage inflows and outflows. Concrete budgeting can also provide default weekly, monthly, and yearly views.

Concrete budgeting may also include a link to other financial products—e.g., deposit, mortgage, HELOC, etc. Concrete budgeting can be implemented in a way so as to automatically sense the financial products associated with a user. In such embodiments, concrete budgeting can query only for user confirmation of discovered products in order to enable easy setup.

Concrete budgeting can provide for a graphical setup of the application preferably wherever possible. In this fashion, the tool will be configured with relatively high usability at the forefront of design.

During a configuration stage, a large default data set can be created based on current card transactions to develop an easy means of reclassifying transactions and/or setting up spending categories. A user can load as much history as possible in order to provide concrete budgeting the ability to learn the savings, investment, and purchase behaviors of the user. Such learning may include a compilation of user spending patterns, investment patterns and/or purchasing events.

Mobile concrete budgeting is preferably completely mobile and device-independent. Accordingly, concrete budgeting can work with any suitable platform—e.g., Windows™, Objective C™, Linux™, Android™, Nokia Symbian™, J2ME™. Thus, concrete budgeting can be compatible with touch-screen devices similar to the iPhone™ manufactured by Apple Computing of Cupertino, Calif., or any other suitable touch-screen PDA, such as Google phone, Blackberry Storm, etc.

In preferred embodiments of the invention, a user can perform almost all tasks using the GUI and/or icons. In addition, the user interface can support touchscreen monitors and mobile devices.

Concrete budgeting can take a user's initial setup of saving, expenditures, credit, debit, etc., along with historical data, and the financial goal(s), and provide a plan or plans for attaining the defined goal(s). Concrete budgeting can further create a multi-period budget of savings & investment goals, as well as expenditure category limits and provide for intermediate evaluation perspectives based on the user-defined periods.

Concrete budgeting can further determine and confirm goal prioritization among the goals provided as well as taking defined timeline and acceptable risk of each goal into account.

Concrete budgeting can also manage multiple transactions in real-time and then provide real-time forward looking metrics based upon this information. For example, based on current savings, investments, and unplanned impulse expenditure, concrete budgeting can notify the user that he or she needs to postpone an additional planned purchase or fund the current financial goal from a different category or source. Concrete budgeting can also provide on-demand sensitivity analysis of impulse expenditures with respect to financial goals and provide the user a recommended course of action if the user chooses to proceed with the purchase.

Throughout a goal's lifetime, concrete budgeting can evaluate current trends and make recommendations to the user for trade-off scenarios for certain expenditures in order to achieve a goal(s) earlier than planned. Rules can be embedded that define if->then scenarios that concrete budgeting can execute if conditions are presented.

In addition, concrete budgeting can include a scenario-based game that can analyze historical data loaded in combination with answers/responses to a list of questions/scenarios presented. Results of such analysis may be provided to a user in order to provide the user a profile of his/her habits and the impacts of the habits on the user's long-term future. The game may be employed from time-to-time to provide additional insight into behaviors.

Once a goal has been attained, concrete budgeting can provide for an optimal portfolio construction for retirement or another goal. Concrete budgeting can also provide analysis of current and planned expenditure requirements. In addition, concrete budgeting may prompt for wealth retention goals. Such wealth retention goals may be characterized in the form of gifts to charities, non-profits, family, etc., as well as bequests to the same.

As purchases are planned and as market conditions change, concrete budgeting can evaluate current financing options available to the user and determine what the optimal financing option is for that user. In addition, concrete budgeting can evaluate current products—e.g., mortgage, HELOC, CDs rates/term etc., and make suggestions to the user to alter their financial product mix. The user may be required to execute on the recommendations.

Concrete budgeting can also provide electronic communications platforms with which a user can set a risk level or threshold that the user is willing to accept with respect to the success and failure of a selected goal. A minimum acceptable risk will be established for risk management. Concrete budgeting may also provide feedback for the determination of a range of acceptable risk based on the goal prioritization. A graphical view may enable the user to help define the acceptable risk range for the particular goal.

Concrete budgeting can provide for rewards for those staying within budget for a particular time frame or cycle or for attaining a particular goal. Incremental rewards can be used to assist with goal attainment. Milestone achievements may be recognized by concrete budgeting and positive feedback provided. Rewards can be in the form of financial institution points and/or products or points as well as coupons and special offers from retailers, merchants, or products/services manufacturers.

Based upon preferably all of the input factors and algorithm recommendations, concrete budgeting can also offer tailored financial advice. Daily tips can be provided based on economic conditions, concrete budgeting's analysis and user preferences. Expert opinions and tips can be sourced from financial institution experts.

User-defined and/or system set time periods for evaluation of the long-term financial future goals can be provided. Concrete budgeting can also analyze relevant factors and make recommendations based on specific points in time. In addition, if time dependent events are scheduled to occur, concrete budgeting will track these events and execute these time-dependent events at the appropriate time.

External events—such as changes in interest rates—can be monitored as well and can/may be offered for notification. Concrete budgeting can provide for pro-active alert messaging for any number of user-defined alerts, temporal events, or non-temporal events. For example, concrete budgeting can notify a user after they have purchased 3 coffees from Starbuck's or notify a user when they are within 20% of their category expenditure during a predetermined time frame.

Default alerts can be provided to ensure ease of setup. Alerts can be in any form such as SMS text messaging, voice mail, email, near field communication, etc.

As part of a Future Consumption Network (“FCN”), concrete budgeting can be integrated with Budget Card Envelopes (“BEC”) as well as Connected Consumption (“CC”).

Preferably, a Future Consumption Network according to the invention can create a closed-loop budgeting, savings, investing, purchasing, and payments marketplace. FCN can implement Connected Consumption, Budget Card and concrete budgeting data in combination with data already available from the interconnected world of communications, credit cards, census, and other networks to redesign the way a consumer purchases.

Companies like Digital Receipts™ and myReceipts.com™ currently offer a means of capturing purchase data in detail, but the capture and management of the data is cumbersome and may require that the user carry a scanner. With the creation of a new payment system involving using mobile devices to purchase items, the line item detail can be downloaded at the time of purchase on the mobile device and available for later categorization.

In another exemplary embodiment of a payment system according to the invention, concrete budgeting can provide a platform to utilize technology available via mobile devices to scan barcodes and maintain a running total of purchases in a particular retail/merchant location as well as over a specified time window against the defined budget. If a user was grocery shopping and wanted to know his or her running total compared to his or her grocery budget, the user could scan every product with the mobile device and concrete budgeting could track the expenditure against his or her grocery budget in real-time.

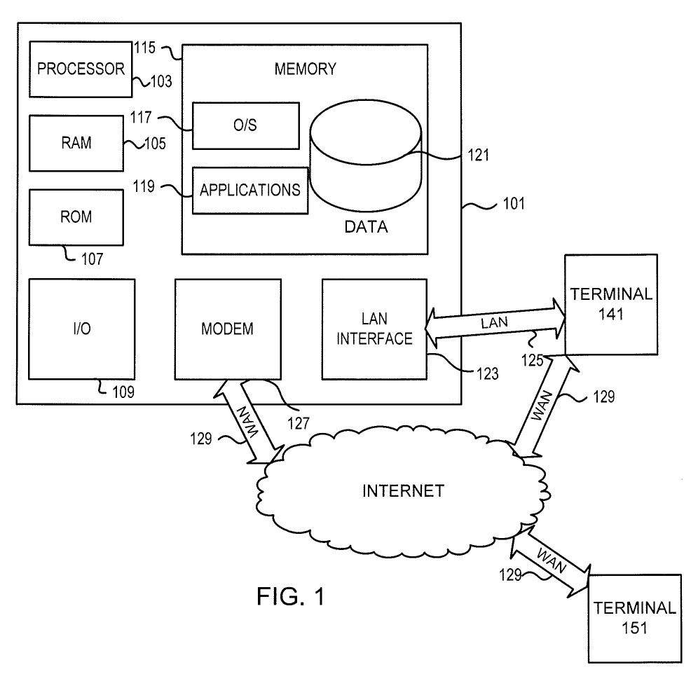

FIGS. 1-5 show illustrative embodiments and features of the invention.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for purchasing information, purchaser information, general purchasing data and statistics, rewards information, financial product information, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

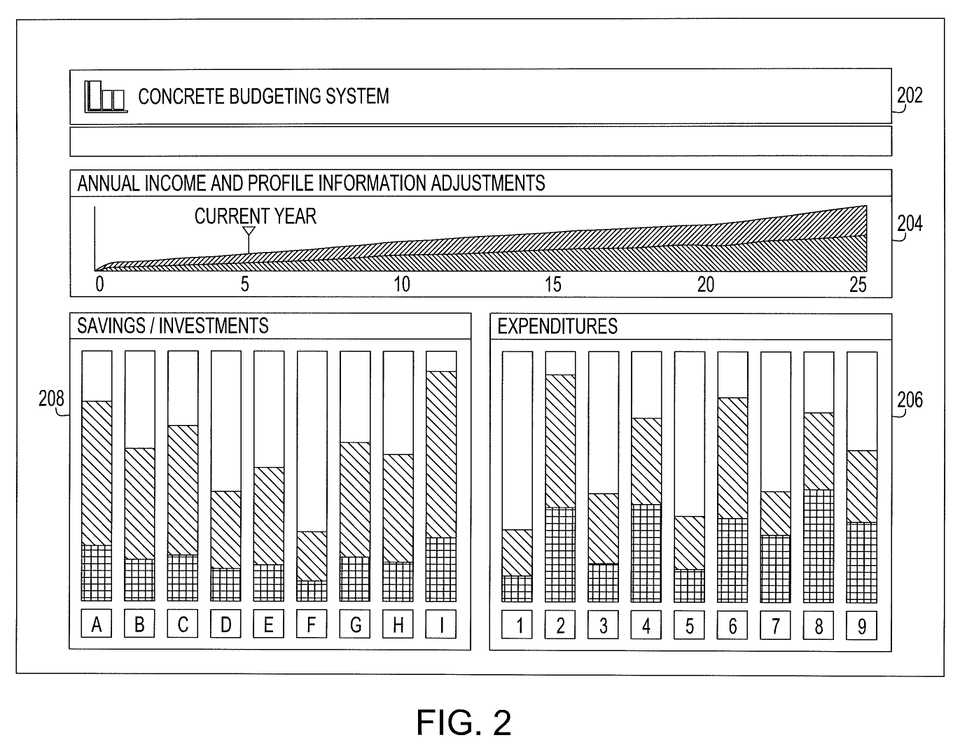

FIG. 2 shows an exemplary illustrative graphical interface that illustrates features of the present invention. The interface includes title bar, 202. The interface also includes region 204 that illustrates annual income and profile information. The lower portion of the charted region may include the projected annual income over a predetermined period of time. The upper portion of the charted region may include a savings goal over the same predetermined period of time.

Region 208 may display savings/investments in a variety of different categories. Region 206 may display a variety of different expenditure categories.

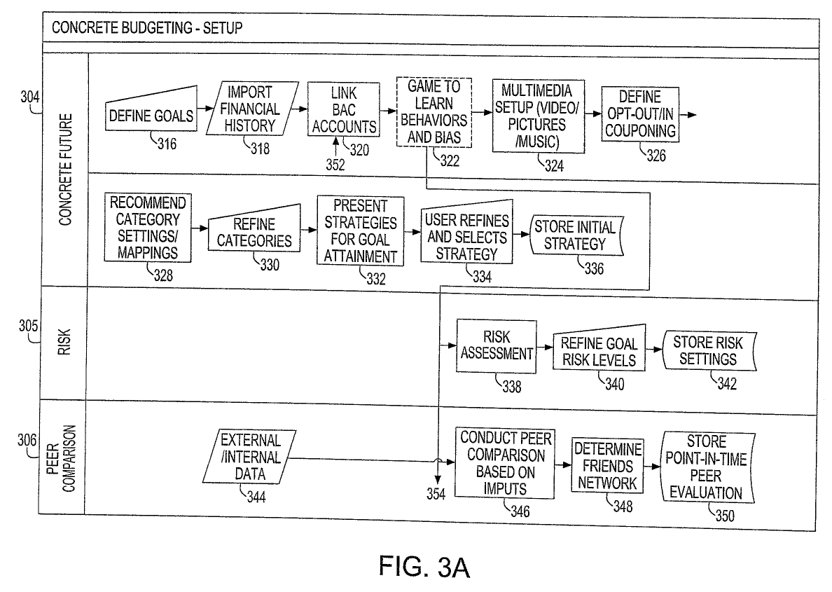

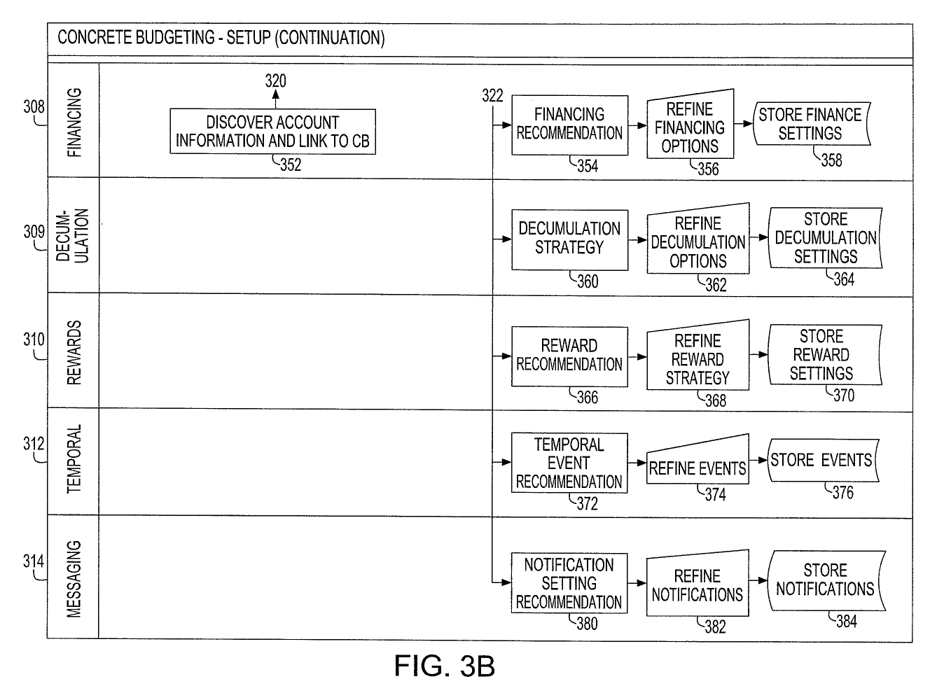

A setup process 302 for concrete budgeting, as shown in FIG. 3A, may include the following sections. Setup process 302 may include a concrete future section 304, a risk section 305 and a peer comparison section 306.

Setup process 302 may preferably initiate a definition of user goals at 316. The process may import user financial history at 318. A link may be established with user accounts at step 320. Additional information directed to financing 308 (shown in FIG. 3B) may be imported into step 320 at step 352 (shown in FIG. 3B).

Optional (as indicated by the broken line) step 322 may then be performed. Step 322 may include providing a game to the user which allows the process to learn and further identify user behaviors and tendencies. Concrete budgeting may further include multimedia setup (video/pictures/music) 324 and a platform for defining opt-out/in couponing 326.

At least in response to the information obtained in steps 316, 318, 320, and 322, the system may recommend category settings at 328.

These categories may be refined by the automated process at step 330. The categories may be presented for goal attainment at step 332. The user may further refine the strategies at step 334, and select a strategy. A selected strategy may be stored at step 336.

With respect to peer comparison, external/internal data 344 may be used to conduct peer comparison at 346 and/or determine a friends network 348. Such peer comparison information and/or friends' network information may be stored at a point-in-time, 350.

A second portion of the setup process shown in FIG. 3A is shown in FIG. 3B. The second portion shows a financing section 308, a rewards section 310, a temporal section 312, and a messaging section 314.

With respect to financing, information may be derived from at least one or more of steps 316, 318, 320, and 322 to provide a financing recommendation, at step 354. Financing options may be refined at 356 and stored at 348.

With respect to decumulation, information may be derived at least from one or more of steps 316, 318, 320, and 322 to provide a decumulation strategy, at step 360. Decumulation strategy may be refined at step 362 and stored at step 364.

With respect to rewards, information may be derived at least from one or more of steps 316, 318, 320, and 322 to provide a rewards recommendation, at step 366. Rewards options may be refined at step 368 and stored at step 370.

With respect to temporal events, information may be derived regarding temporal events, and/or scheduled events at least from one or more of steps 316, 318, 320, and 322 in order to provide a recommendation based on temporal events, at step 372. Information derived from temporal events may be refined at step 374 and stored at step 376.

With respect to messaging, information may be derived at least from one or more of steps 316, 318, 320, and 322 to provide a default messaging recommendation, at step 380. Messaging options may be refined at step 382 and stored at step 384.

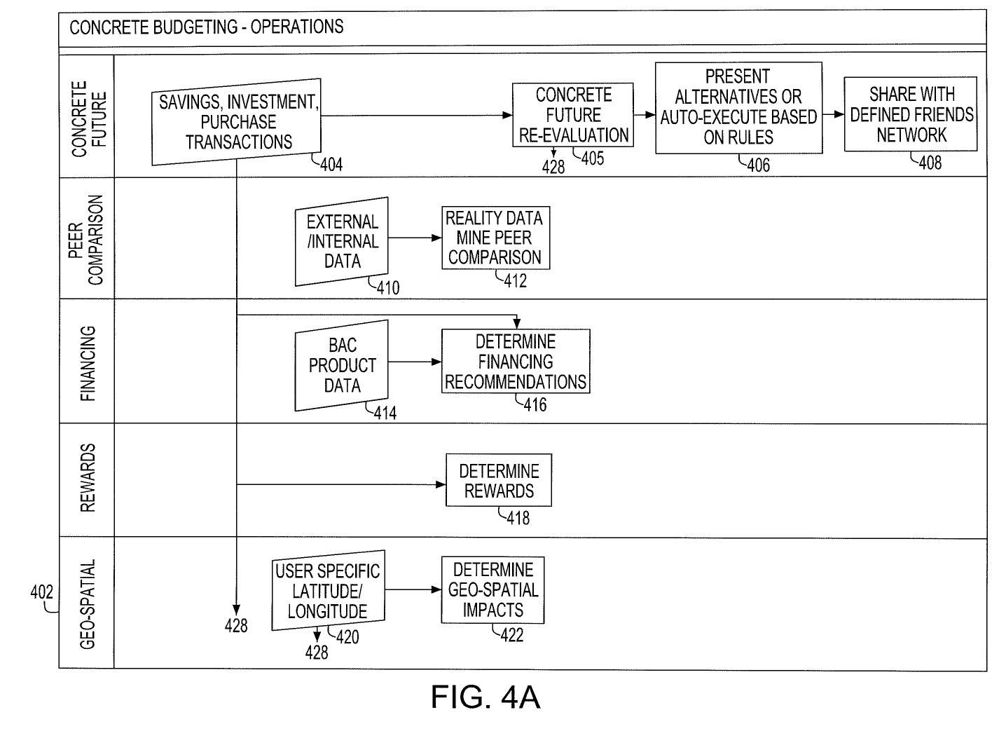

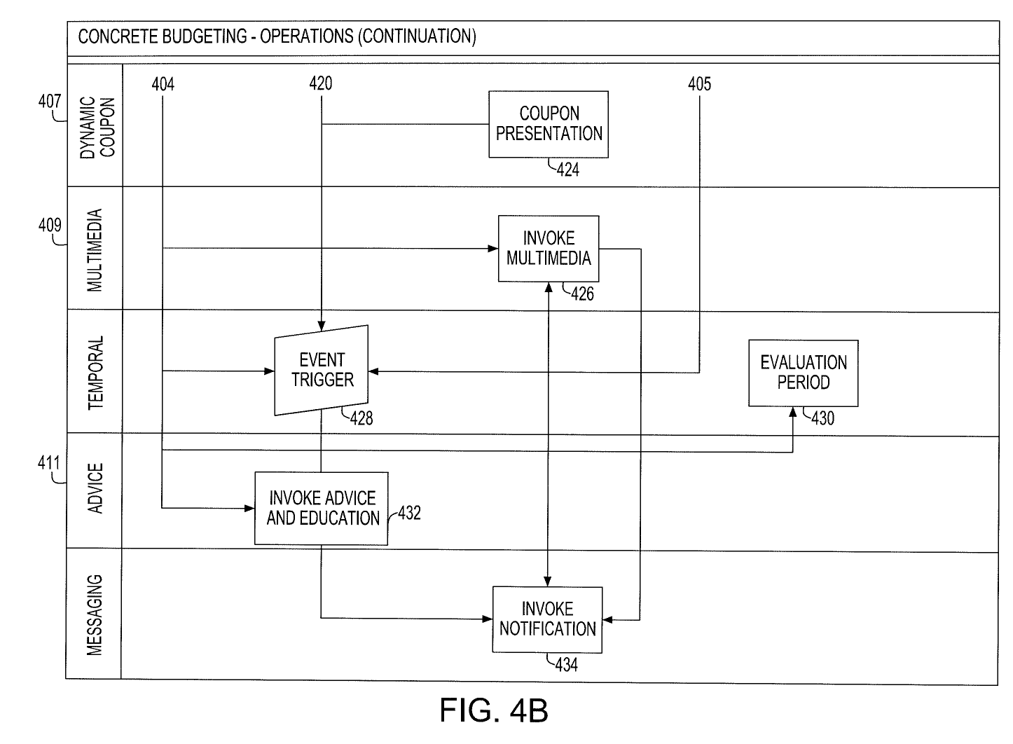

FIG. 4A shows an illustrative process that shows entity operations according to the invention. The process has also been broken down into substantially similar constituent parts—i.e., concrete future, peer comparison, financing, rewards, temporal, and messaging—as shown with respect to the process setup of FIG. 3, with the exception of the additional constituent parts relating to geo-spatial application 402, dynamic coupon part 407, multimedia part 409, and advice 411. The constituent parts described with respect to FIG. 3A-3B have not been described with respect to FIG. 4A-4B.

The operations process may be initiated and/or restarted with a savings transaction, an investment transaction and/or a purchase or sale 404. Such an event may drive a concrete future goal reevaluation, 405. The future re-evaluation may cause the process to present alternatives to the user and/or cause systems and methods according to the invention to auto-execute a task based on predetermined rules, 406.

In combination with external and/or internal data 410, the process may also commence a peer comparison, 412. If the peer comparison obtains a result that rises above a predetermined threshold, the peer comparison may lead back to future re-evaluation, 405.

In combination with financial product data, 414, the process may also determine financing recommendations, 416. As with the peer comparison, if the financing recommendations warrant, a concrete future re-evaluation may commence, 405.

The determination of financing recommendations, 416, together with a savings, investment or purchase may cause the process to determine if any rewards are due the user, 418.

In addition, the savings, investment, and/or purchase, 404, may be treated as an event trigger which, in itself, may cause a concrete future goal re-evaluation, 405, may inaugurate an evaluation period 430, or may invoke a notification 434.

A geo-spatial aspect of the process may relate to receiving information concerning user specific latitude/longitude information 420 and/or the geo-spatial impact of a user location.

FIG. 4B shows a dynamic coupon process aspect 407 including coupon presentation 424. Coupon presentation may include dynamic presentation of a coupon to a user.

Multimedia section 409 may invoke multimedia 426 as needed in order to enhance the budgeting experience. An event trigger at 428 may invoke an evaluation period 430. An event trigger may receive savings and purchase 404 information, a concrete future re-evaluation 420, advice and education 432, or any other suitable information in order to be triggered.

Advice section may invoke advice and education 432, as needed.

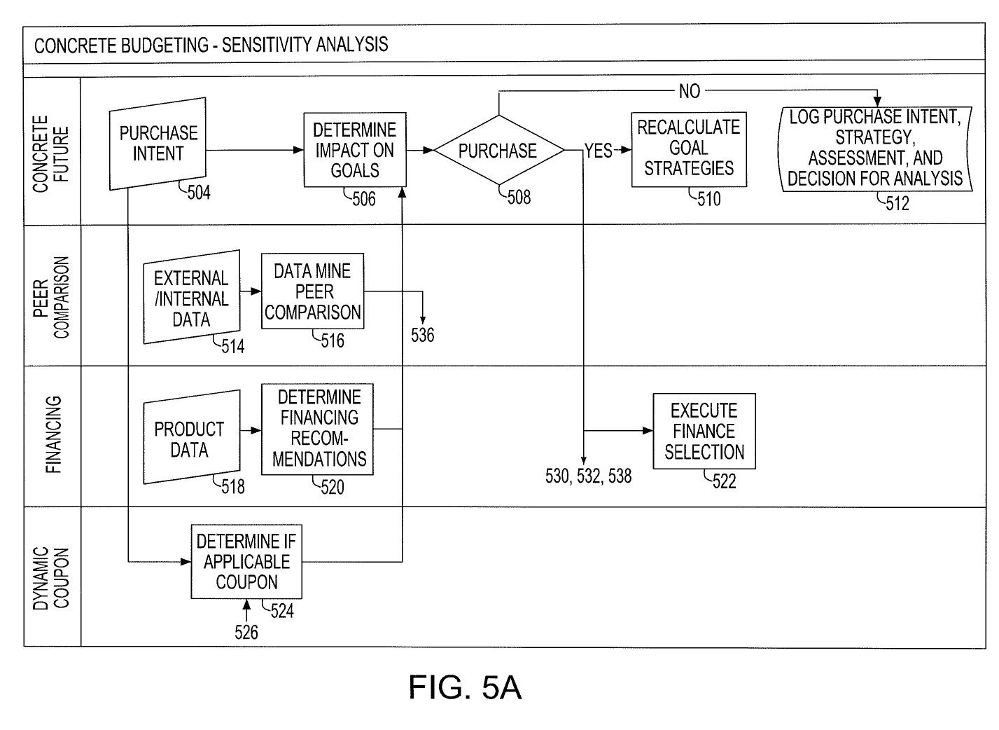

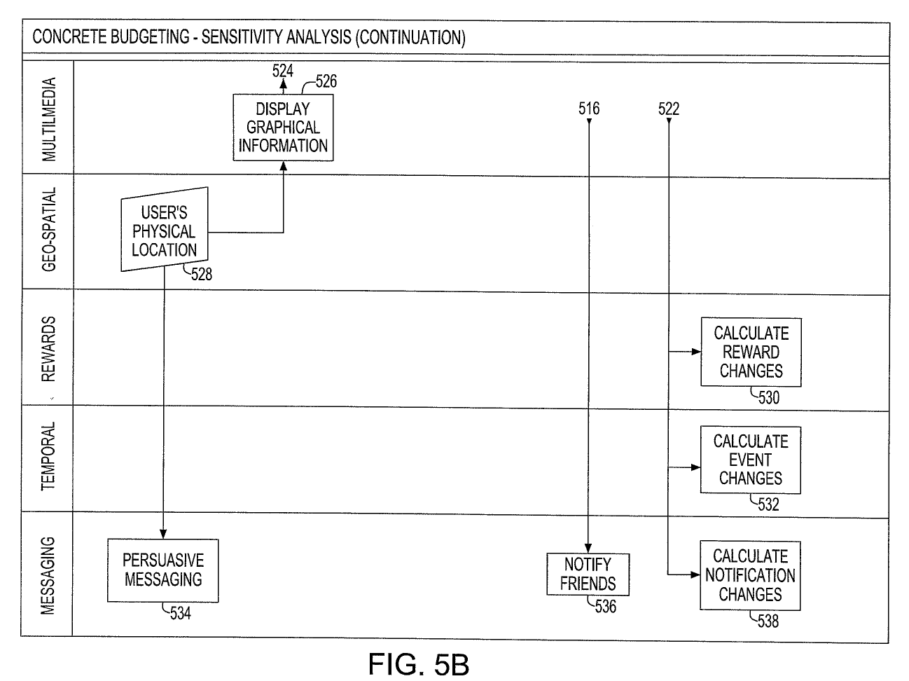

FIG. 5A shows an illustrative process for providing sensitivity analysis according to the invention. A registration of a purchase intent, 504, may commence a determination of the impact of the purchase on long term goals, 506.

Such a determination, 506, may also be based on a peer comparison, 516, which may, in turn, be based on external/internal data, 514, and/or a determination of financing recommendations, 520, which may be based on financial product data, 518. A determination of the existence of an applicable coupon may be invoked at 524.

Following the determination of the impact of the purchase on goals, 506, a purchase may ensue, 508. The purchase may initiate a recalculation of goal strategies, 510, and/or execution of a financing selection, 522, a calculation of reward changes 530, a calculation of event changes 532, and/or a calculation of notification changes 538 (all shown in FIG. 5B.)

In the event that a purchase does not occur, the process may log the purchase intent, strategy assessment and decision for analysis and/or for changing future guidance to accommodate possible repressed purchasing needs, 512.

FIG. 5B shows a continuation of a process for sensitivity analysis according to the invention. In addition to steps 530, 532, and 538 described above, FIG. 5B further shows obtaining a user's physical location 528 and displaying such information 526. In addition, FIG. 5B shows providing the user with persuasive messaging 534 which may be responsive, at least in part, to the user's location.

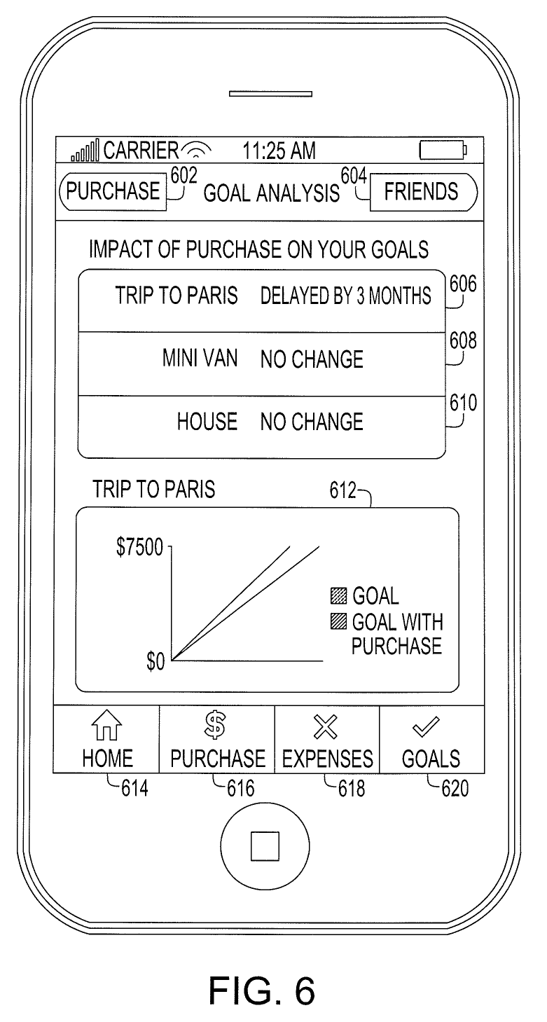

FIG. 6 shows another exemplary illustrative graphical interface that illustrates features of the present invention. FIG. 6 represents a goal analysis based graphical interface. The graphical interface also includes a purchase option 602 and/or a friends option 604. Purchase option 602 provides an electronic platform to transfer the user from the goal analysis graphical interface shown in FIG. 6 to a graphical interface associated with purchasing an item or service.

FIG. 6 also includes a section that illustrates the impact of a purchase on user goals. Field 606 shows that a user trip to Paris may be delayed three (3) months as a result of a purchase. Fields 608 and 610, on the other hand, show that the purchase may not affect plans to purchase a minivan and/or a house.

It should be noted that any number of rules and/or algorithms may be implemented to determine what goals are affected by a purchase and what goals are not affected. For example, a participant may designate that only excess incoming funds over a certain threshold value may be set aside for a trip to Paris, whereas all excess funds less than the threshold value may be used for a different goal such as buying a minivan. According to such a rule, the minivan would get funded each an every time excess funds entered the account, whereas the trip to Paris would only get funded when a certain level of incoming funds was achieved. Thus, a predetermined purchase may affect achievement of one goal but not affect achievement of another goal.

FIG. 6 also shows a graphical indication of the effect of the purchase on a predetermined user goal such as a trip to Paris. Finally, FIG. 6 also includes additional tabs which may be used to access home 614, purchase 616, expenses 618, and/or goals 620.

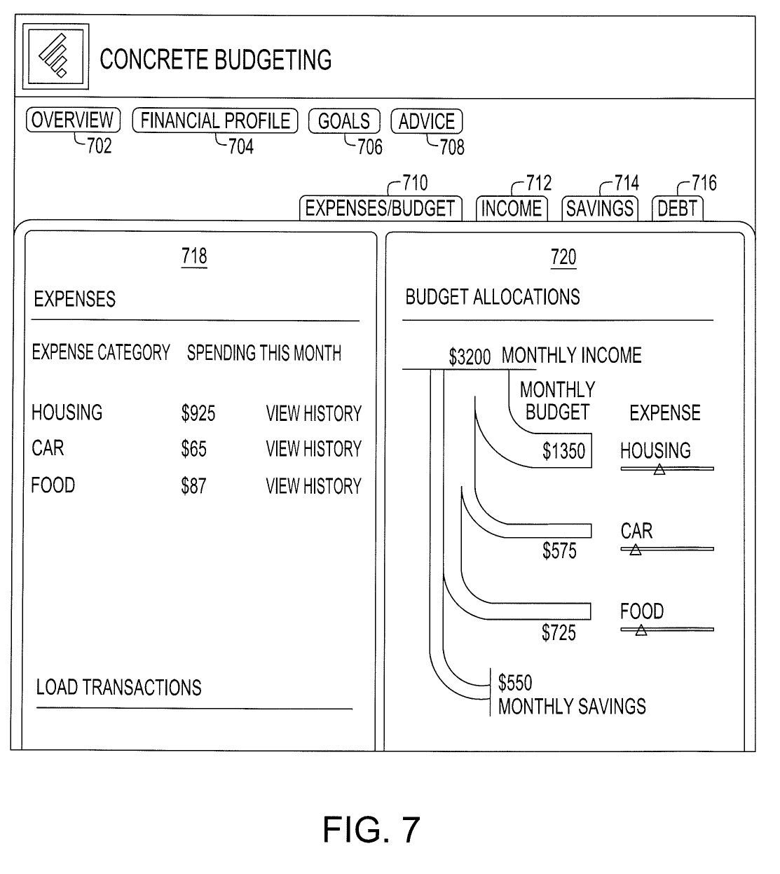

FIG. 7 shows yet another exemplary illustrative graphical interface that illustrates features of the present invention. FIG. 7 includes tabs for system overview 702, user financial profile 704, goals 706, advice 708 (which may include advice from friends and/or advice from a predetermined financial institution), expenses/budget 710, income 712, savings 714, and debt 716.

Section 718 shows the expenses in full visual rendering. Section 720 shows budget allocations in full visual rendering.

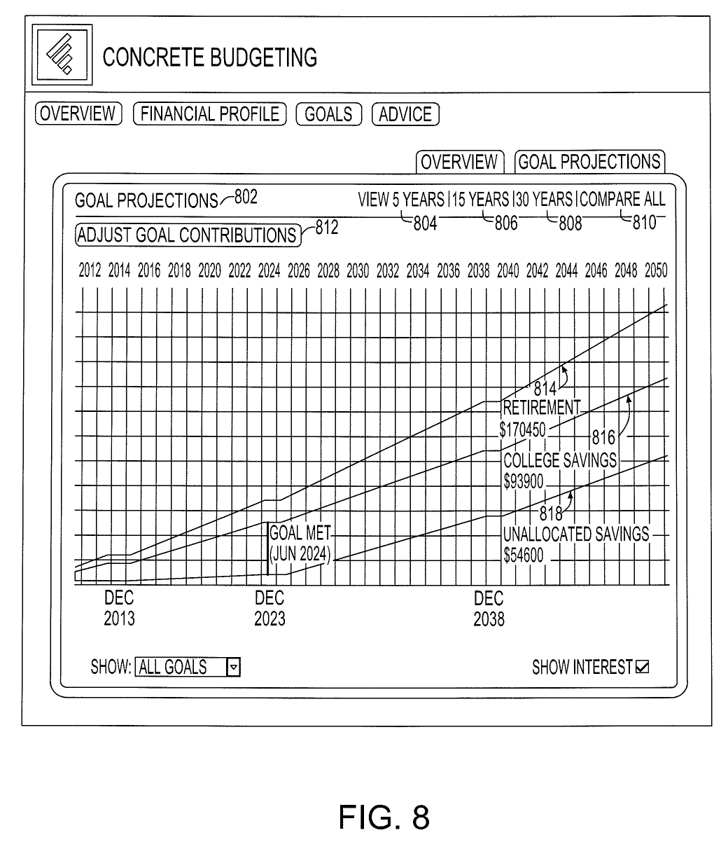

FIG. 8 shows still another exemplary illustrative graphical interface that illustrates features of the present invention. The illustrative graphical interface in FIG. 8 corresponds to a financial profile of a user. Such an overview may include goal projections 802, various terms for projections 804, 806, 808, and 810, a tab for adjusting goal contributions 812, a retirement projection line 814, a college saving projection line 816, and an unallocated savings line 818.

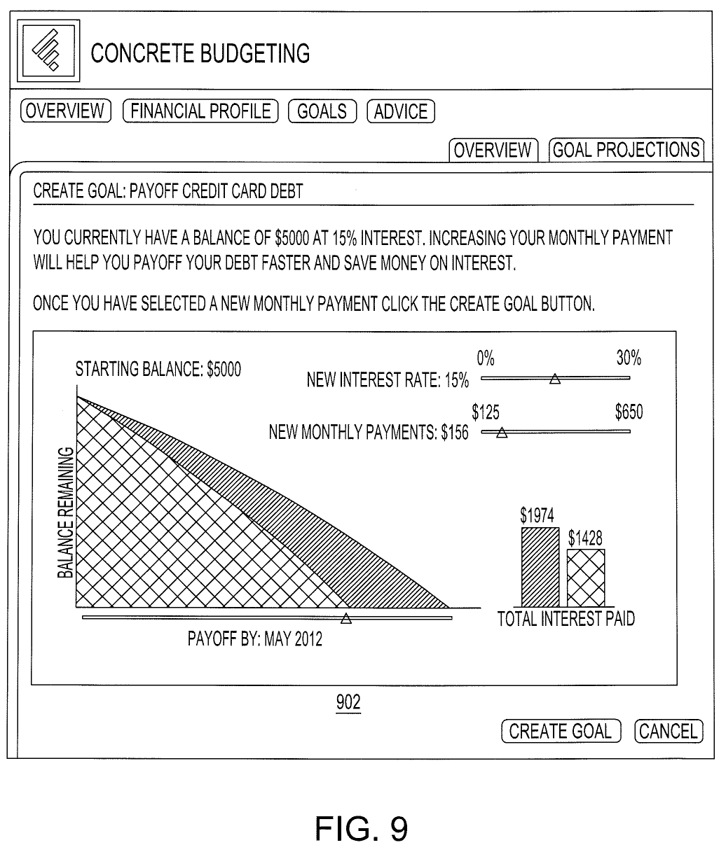

FIG. 9 shows yet another exemplary illustrative graphical interface that illustrates features of the present invention. FIG. 9 shows a goal create screen display 902. Screen display 902 may preferably indicate various characteristics of goal achievement. For example, screen display 902 preferably shows how much interest and how much balance has been paid on a credit card debt. In addition, screen display 902 may include user-adjustable sliders that can help a user determine the effect of a new interest rate and/or change of monthly payment on the payoff date and total interest paid.

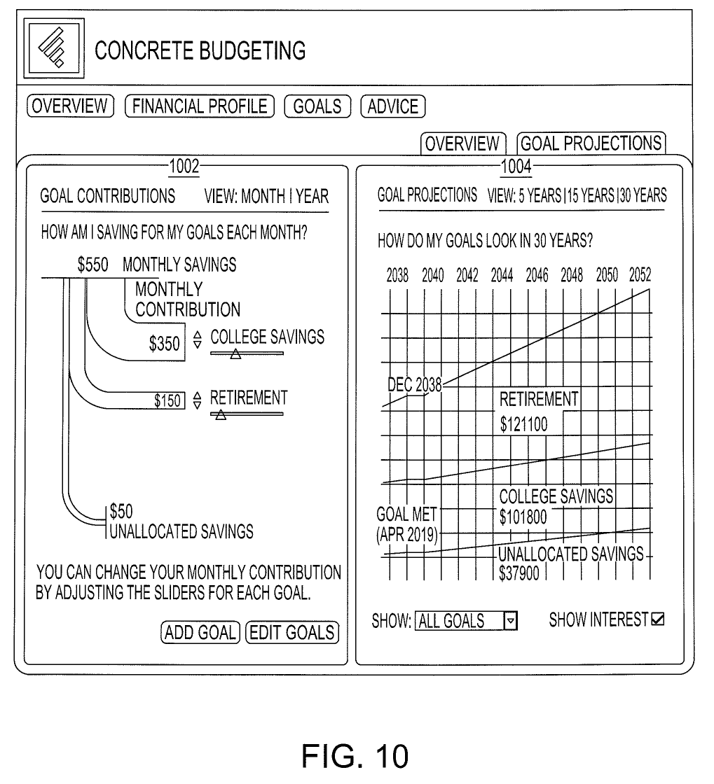

FIG. 10 shows another exemplary illustrative graphical interface that illustrates features of the present invention. FIG. 10 includes sections 1002 and 1004. Section 1002 shows a graphical display of goal contributions. The various monthly contributions may be adjusted using sliders. Section 1004 shows goal projections for various financial goals such as retirement, college savings, and/or unallocated savings.

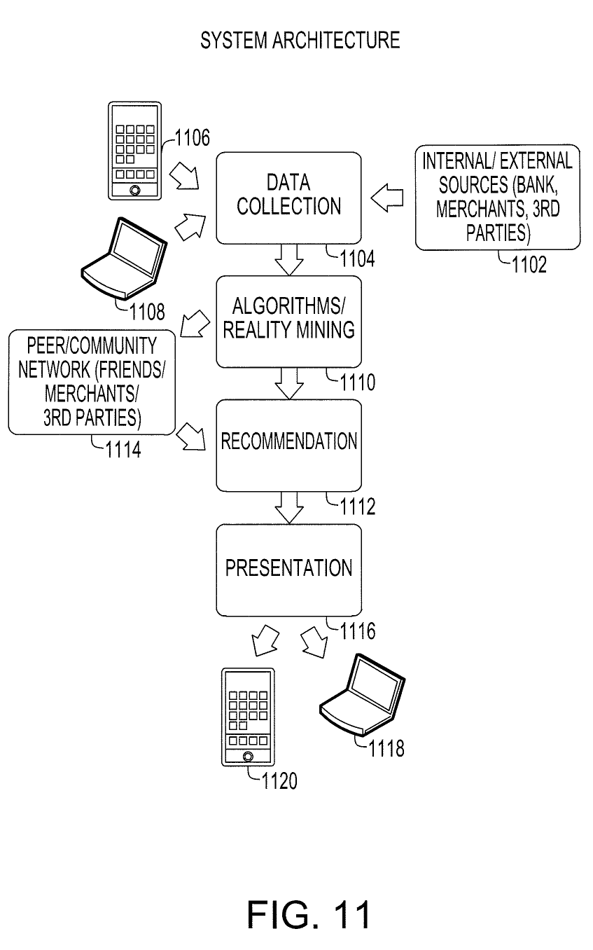

FIG. 11 shows an exemplary system architecture of a system according to the invention. The system architecture may include a handheld device 1106 and/or a laptop computer 1108. The system may preferably receive, as part of its data collection 1104, information from internal/external sources (banks, merchants, 3^{rd} parties, etc.) 1102.

The data collected may be mined using algorithms and/or reality mining. Such algorithms and/or reality mining may preferably analyze the data in order to obtain various statistics regarding the peer/community network of the user 1114, and/or to provide a recommendation 1112 to the user.

The recommendation may be presented at step 1116 on either the handheld device 1120 of the same or a different user, and/or a laptop computer 1118 of either the same or a different user.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for supporting budgeting initiatives have been provided. Persons skilled in the art will appreciate that the present invention can be practiced by other than the described embodiments, which are presented for purposes of illustration rather than of limitation, and that the present invention is limited only by the claims that follow.

What is claimed is:

1. One or more computer-readable media storing computer-executable instructions which, when executed by a processor on a computer system, perform a method for determining the effect of a purchase on a budgeting goal, the method using an electronic information processing platform, the method comprising:
receiving information from a participant regarding the intent to purchase an item;
determining the effect of the purchase on the goal;
in response to an occurrence of the purchase, recalculating a goal strategy; and
in response to a registration of a failure to purchase, logging the purchase intent.

2. The media of claim 1 wherein, in the method, the registration of a failure to purchase comprises allowing a predetermined amount of time to elapse without receiving information corresponding to the execution of a purchase.

3. The media of claim 1 wherein, in the method, the registration of a failure to purchase comprises receiving a notification of a decision not to purchase.

4. The media of claim 1 wherein, in the method, the determining the effect of the purchase on the goal is based at least in part on a peer comparison.

5. The media of claim 1 wherein, in the method, the determining the effect of the purchase on the goal is based at least in part on a financing recommendation relating to the purchase.

6. The media of claim 1 wherein, in the method, the occurrence of the purchase transmits an electronic message via the electronic information processing platform to execute a finance selection.

7. The media of claim 1 wherein, in the method, the occurrence of the purchase transmits an electronic message via the electronic information processing platform to calculate the effect of the purchase on a rewards decision.

8. The media of claim 1 wherein, in the method, the occurrence of the purchase transmits an electronic message via the electronic information processing platform to calculate the effect of the purchase on a scheduled event.

9. The media of claim 1 wherein, in the method, the occurrence of the purchase transmits an electronic message via the electronic information processing platform to calculate the effect of the purchase on a future notification.

10. A method for operating an electronic information processing platform, the method comprising:
receiving an electronic confirmation of one of a purchase, a savings transaction, and an investment transaction;
performing a reevaluation of a future savings goal in response to the confirmation;
and performing one of the following in response to the reevaluation: presenting an alternative to the future savings goal and auto-executing a process, said auto-executing being based on pre-determined rules.

11. The method of claim 10, the performing a reevaluation comprising performing the reevaluation based at least in part on a peer comparison of the user to a relevant peer group.

12. The method of claim 10, the performing a reevaluation comprising reevaluating based at least in part on financing recommendations.

13. The method of claim 10, the performing a reevaluation comprising reevaluating based at least in part on a rewards determination.

14. The method of claim 10, the confirmation comprising an event trigger.

15. The method of claim 14, the event trigger initiating a notification process.

16. The method of claim 10, the confirmation initiating a notification process.

17. The method of claim 14, the event trigger initiating an evaluation period.

18. The method of claim 10, the confirmation initiating an evaluation period.
